(19) United States
(12) Patent Application Publication
(10) Pub. No.: US 2012/0040320 A1
(43) Pub. Date: Feb. 16, 2012

(54) Injection Simulation Device and Methods Thereof

(76) Inventor: Daniel A. Nadeau, Kittery, ME (US)

(21) Appl. No.: 13/204,240

(22) Filed: Aug. 5, 2011

Related U.S. Application Data
(60) Provisional application No. 61/373,515, filed on Aug. 13, 2010.

(51) Int. Cl. G09B 23/28

(52) U.S. Cl. 434/262

(57) ABSTRACT

An injection simulation device and methods thereof is provided. The device includes an elongated handle having a first end and a second end, wherein the elongated handle has a sidewall with an interior surface defining an interior space, wherein the interior space is completely empty. An end portion is integral with the sidewall and positioned at the first end of the elongated handle, the end portion enclosing the first end of the elongated handle. A first attachment structure is integral with the second end of the elongated handle. A hollow needle is connected to a hub having an end point, wherein the end point has a second attachment structure engagable with the first attachment structure to connect the hub to the second end of the elongated handle.

### CROSS REFERENCE TO RELATED APPLICATION

This application claims benefit of U.S. Provisional Application Ser. No. 61/373,515 entitled, “A Pen Needle Demonstration Apparatus and Method of Using Thereof,” filed Aug. 13, 2010, the entire disclosure of which is incorporated herein by reference.

### FIELD OF THE DISCLOSURE

The present disclosure is generally related to medical needles and more particularly is related to an injection simulation device and methods thereof.

### BACKGROUND OF THE DISCLOSURE

Pen needles are commonly used with injection pens to deliver injectable medications into the body. A pen needle includes a hollow needle attached to a plastic structure that is attached to an injection pen. The injection pen houses medication, and after priming, when the plunger is compressed, the medication flows from the injection pen and through the hollow needle. Depending on the type and/or amount of medicine given and the length of the needle, the needle may be inserted into different layers of subcutaneous tissue.

Many people who require medicine administered via a needle may require the medicine on a daily basis, multiple times a day, multiple times a week, weekly, multiple times a month, monthly, a few times a year or sporadically. Over time, people become accomplished and efficient with use of an injection pen and pen needle. However, nearly all first time users fear the use of a pen needle. Also an injection pen with medication and pen needle may be intimidating. Incorrect use of the pen needle and injection pen, such as accidentally applying too much pressure on the plunger of a primed injection pen, may result in unwanted exposure to medication. In addition, accidental reuse of a pen by a different person, whether a demonstration pen or a pen that contains actual medication, may result in exposure to blood borne pathogens.

Thus, a heretofore unaddressed need exists in the industry to address the aforementioned deficiencies and inadequacies.

### SUMMARY OF THE DISCLOSURE

Embodiments of the present disclosure provide an injection simulation device and methods thereof. Briefly described, in architecture, one embodiment of the device, among others, can be implemented as follows. The injection simulation device includes an elongated handle having a first end and a second end, wherein the elongated handle has a sidewall with an interior surface defining an interior space, wherein the interior space is empty. An end portion is integral with the sidewall and positioned at the first end of the elongated handle, the end portion enclosing the first end of the elongated handle. A first attachment structure is integral with the second end of the elongated handle. A hollow needle is connected to a hub having an end point, wherein the end point has a second attachment structure engagable with the first attachment structure to connect the hub to the second end of the elongated handle.

The present disclosure can also be viewed as an injection pen simulation device. Briefly described, in architecture, one embodiment of the device, among others, can be implemented as follows. The injection simulation device includes a hollow needle connected to a hub having an end point. The end point of the hub is removably connected to an end of a handle body, wherein when the end point of the hub is connected the end of the handle body, the injection simulation device has no moving parts.

The present disclosure can also be viewed as providing methods of constructing an injection pen simulation device. In this regard, one embodiment of such a method, among others, can be broadly summarized by the following steps: providing a fully-static, handle body having no moving parts; and connecting a hollow needle having a hub with an end point to a first side of the handle body, thereby forming a empty interior space within the handle body and hub.

The present disclosure can also be viewed as providing methods of using an injection pen simulation device. In this regard, one embodiment of such a method, among others, can be broadly summarized by the following steps: providing a fully-static, handle body having no moving parts connected at a first side to a hollow needle having a hub with an end point, thereby forming a empty interior space within the handle body and hub; placing the hollow needle proximate to a body part; and inserting the hollow needle into the body part, thereby simulating use of a medicine-providing injection pen.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is an exploded plan view illustration of an injection simulation device, in accordance with a first exemplary embodiment of the present disclosure.

FIG. 2 is a plan view illustration of the injection simulation device, in accordance with the first exemplary embodiment of the present disclosure.

FIG. 3 is a cross-sectional illustration of the injection simulation device, in accordance with the first exemplary embodiment of the present disclosure.

FIG. 4 is a plan view illustration of the injection simulation device, in accordance with a second exemplary embodiment of the present disclosure.

FIG. 5 is a flowchart illustrating a method of constructing an injection simulation device, in accordance with a third exemplary embodiment of the present disclosure.

FIG. 6 is a flowchart illustrating a method of using an injection simulation device, in accordance with a fourth exemplary embodiment of the present disclosure.

### DETAILED DESCRIPTION

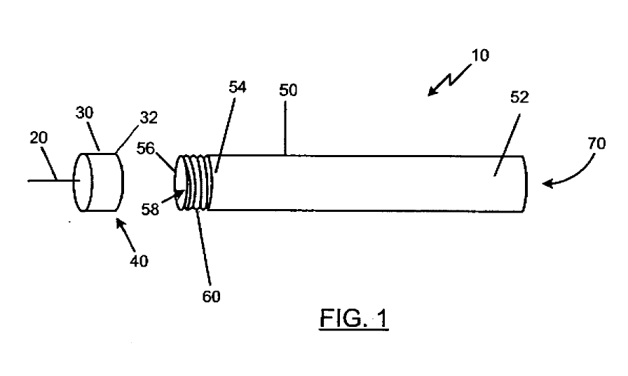

FIG. 1 is an exploded plan view illustration of an injection simulation device 10, in accordance with a first exemplary embodiment of the present disclosure. The injection simulation device 10, which may be referred to herein simply as ‘device 10,’ includes an elongated handle 50 having a first end 52 and a second end 54. The elongated handle 50 has a sidewall 56 with an interior surface defining an interior space 58, wherein the interior space 58 is completely empty. An end portion 70 is integral with the sidewall 56 and positioned at the first end 52 of the elongated handle 50, wherein the end portion 70 encloses the first end 52 of the elongated handle 50. A first attachment structure 60 is integral with the second end 54 of the elongated handle 50. A hollow needle 20 is connected to a hub 30 having an end point 32. The end point 32 has a second attachment structure 40 engagable with the first attachment structure 60 to connect the hub 30 to the second end 54 of the elongated handle 50.

The device 10 may assist people with using injection pens by providing a simulation of use of the injection pen with a structure that lessens the complications and associated fear of injection pens. Commonly a patient of a medical facility may be diagnosed with a condition that requires the use of an injectable medicine. The patient may not be familiar with the idea of using an injection needle, since they often carry stigmas of pain and uncomfortable experiences. A doctor or other medical care provider may use the device 10 to help the patient overcome fear of using an injectable medicine. Additionally, the device 10 may be used to demonstrate proper needle use before administration of medicine with an injection pen without wasting expensive medicine or spreading bacteria through reused injection pens. The device 10 may be used to simulate the use of any type of injection pen, syringe, subcutaneous needle or catheter or other injection-based medical devices. This device may help overcome the fear of the needle by attaching the needle to an innocuous handle and allowing the patient to experience the use of the needle in a less threatening form.

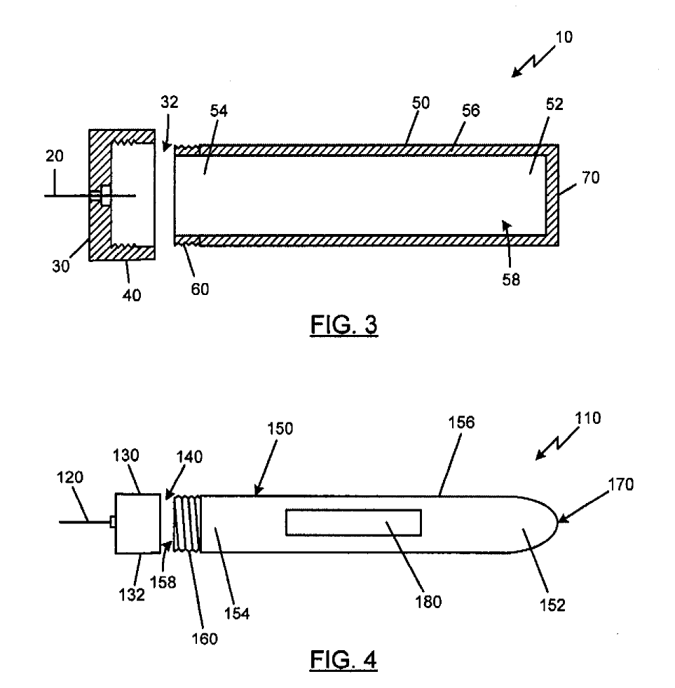

The hollow needle 20 used with the device 10 may include any type of needle or cannula that is used to administer medicine. This includes a hollow needle 20 with any gauge and length, each of which may be subject to the specific user or the eventual medicine that the user is prescribed. The hollow needle 20 may be connected to or embedded within the hub 30, and thereby be supported and generally handled by the hub 30. The hollow needle 20 generally traverses from one side of the hub 30, through the hub 30, and to the other side of the hub 30 (shown in FIG. 3). The construction of the hollow needle 20 may commonly be done during a manufacturing process, where the hollow needle 20 and hub 30 are joined and subject to a sterilizing process, prior to being enclosed in a sterile package. However, the hollow needle 20 and hub 30 may also be connected prior to a use by a patient. Any variation of connecting the hollow needle 20 and the hub 30 that result in a unitary structure are also considered within the scope of the present disclosure.

The hub 30 may have a partially hollow interior with a first attachment structure 40 located at the end point 32. Commonly, the first attachment structure 40 will include a threaded fastener having plurality of threads that engage with another threaded fastener on the elongated handle 50 having a plurality of receiving structures positioned to receive the threads. As is shown in FIG. 1, the threaded fastener on the elongated handle 50 may be the second attachment structure 60 located on the second end 54 of the elongated handle 50. For example, some conventional injection pens and hub structures use a threaded attachment system, whereas other system may use a biased click-based fastening system, a twist-on fastener, or any other known mechanical connection. Any of these features or structures may be used on the device 10, such that the elongated handle 50 of the device 10 may be compatible with any of the existing or currently used hub systems.

The hub 30 with the end point 32 may be substantially similar to the structures conventionally used with medical injection pens. These structures are produced by a number of companies and may include variations with attachment to the injection pen. For example, the hub 30 with the hollow needle 20 may be the same as conventional pen needles that are used to administer subcutaneously dosed medication. This medicine is commonly found within injection pens used in the medical industry, and includes insulin, insulin analogues, GLP-1 analogues, epinephrine, parathyroid hormones, growth hormone, octreotide, all peptides and any other medications that are administered by a subcutaneous route.

The elongated handle 50 may be a cylindrical structure that may simulate the body of a conventional injection pen. The elongated handle 50, which may be referred to as a handle body, includes a sidewall 56 with interior and exterior surfaces. The end portion 70 is integral with the sidewall 56 and positioned at the first end 52 of the elongated handle 50 to enclose the first end 52. The second end 54 may be open, such that the interior space 58 is open to an outside atmosphere when the hub 30 is not connected to the elongated handle 50. When the hub 30 is connected to the second end 54, the interior space 58 is substantially enclosed, since the interior to space 58 is fully enclosed, with the exception of the hollow passage or fluid-transporting capable pathway that is within the needle 20. It is noted that similar configurations of the sidewalls 56 and end portion 70 are available. For example, the elongated handle 50 may have cross-sectional shapes other than just circular, such as oval, square, or any other shape. Additionally, the elongated handle 50 may include any ergonomic features on the exterior surface, such as texturing to assist with properly holding the elongated handle 50.

A user may contact the exterior surface when the user is holding the device 10, such as when it is being used to simulate an injection of medicine. The sidewall 56 between the exterior surface and the interior surface may have any thickness of material, and may be constructed from any type of material, commonly a medical grade plastic or similar compound. The interior surface may define the interior space 58 that is completely empty within the elongated handle 50.

In other words, the interior space 58 includes absent of any structures, devices, or other features, thus making the interior space 58 of the elongated handle 50 empty. This also means that the elongated handle 50 is completely static since it has no moving parts either within the interior space 58, or external of the exterior surface. It is noted that finite particles, such as dust or moisture may be located within the interior space 58, especially prior to when the hub 30 is connected to the elongated handle 50, but it is devoid of any fluids. However, the interior space 58 is free from medical-purposed structures, such as medicine containers, dosing apparatuses, fluids and the like.

As one can see, the elongated handle 50 may be far easier to manufacture than conventional injection pens, since it does not include any additional parts to be designed, manufactured, and assembled with the handle body. Thus, the elongated handle 50 may be far less expensive than conventional injection pens. In contrast with the elongated handle 50 of the device 10, conventional injection pens include a number of devices located within the handle body that are used to correctly measure and dose out the medicine contained therein. For example, a conventional pen may include, within the handle body, a container for holding the medicine and a medicine dosage device, which allows the user to rotate an end portion of the injection pen to select the appropriate amount of medicine to be released. These features are needed in the conventional injection pens because conventional injection pens must be capable of releasing medicine. In the current device 10, simulating the injection pen requires no medicine to be released, and thus, the current device 10 requires no containers to hold the medicine within the elongated handle 50, nor any devices to correctly dose out the medicine, or administer it.

Conventional injection pens are complicated devices, and they are often intimidating to beginning users. A first time user must not only learn to properly insert the needle into their body, or another's body, but they also must learn how to correctly set the injection pen to administer an appropriate amount of medicine. As a result, beginning users often shy away from wanting to use conventional injection pens. This leads to a situation where a medical provider is less likely to recommend or prescribe a medicine that requires an injection pen, which may easily limit the treatment of illnesses and other conditions. The device 10 described herein may provide a solution to this problem, but providing a simple structure that lessens the intimidation of using an injection pen, thereby allowing a beginning user to learn how to properly inject medicine. Once the user has become proficient at using the device 10, the user may then be more apt to use a conventional injection pen without hesitation or fear.

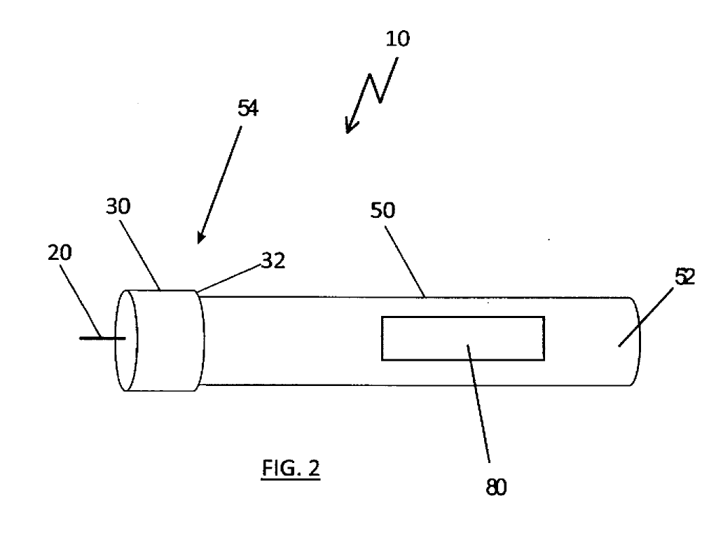

FIG. 2 is a plan view illustration of the injection simulation device 10, in accordance with the first exemplary embodiment of the present disclosure. FIG. 2 illustrates the hollow needle 20 with the hub 30 in a connected position with the second end 54 of the elongated handle 50. In practice, the injection simulation device 10 may be used to demonstrate how to properly hold an injection pen and insert needle prior to using the injection pen. In other words, one can learn how to properly angle a pen device and with a smooth motion insert the needle into subcutaneous tissue prior to using a device containing any medicine by using the device 10 as a simulation tool. As previously mentioned, the device 10 may reduce a user's fear administering medication with an injection pen and pen needle, since the injection simulation device 10 is less intimidating than a conventional injection pen and pen needle. Using the device 10 may reduce the risk of blood-borne pathogens when compared to conventional injection pens, since injection pens, whether demonstration pens or pens that contain actual medication, even with replacement of the pen needle, may accidentally be used for more than one person and therefore carry the risk of infection for the second or any subsequent user of the pen.

The device 10 may also prevent an accidental injection of medication from accidentally applying pressure to the plunger of a primed injection pen during a demonstration. For example, a beginning user may easily simulate an injection of medicine with the device 10 without actually bringing medicine in contact with their body. In addition to all of the benefits described herein, use of the using the device 10 may also reduce the costs of administering medical care in a situation where a patient declines the use of an injection pen after trying to use a medication-filled injection pen, which would then need to be disposed to avoid the risk of blood-borne pathogens.

In use, the hub 30 with hollow needle 20 attached thereto may be removed from a sterile packaging. The hub 30 may then be affixed to the second end 54 of the elongated handle 50 by engaging the first attachment structure 40 on the hub 30 with the second attachment structure 60 on the second end 54 of the elongated handle 50. Once the hub 30 is successfully connected with the elongated handle 50, a user may control the hollow needle 20 via the elongated handle 50.

Accordingly, the user may practice inserting the hollow needle 20 into any body part, such as the flesh of an arm, a leg and/or an abdomen. Practicing using the device 10 allows the user to more conveniently learn, and for a nurse or other medical professional to more easily teach, how to administer medicine via a hollow needle 20 before running the risk of wasting medicine or exposing the user to risks associated with wrongfully administered medicine and reduce the risk of exposure to blood-borne pathogens.

Use of the device 10 may include any of the procedures, steps, or configurations that are commonly found with conventional injection pens. In fact, the use of the device 10 may be to simulate as near as possible, the exact process that the user will be required to complete with a conventional injection pen. For example, the user may begin first by orienting the elongated handle 50 without the hub 30 attached thereto, just to get a feel of the proper orientation and positioning of the elongated handle 50. The user may also practice applying the second end 54 of the elongated handle 50 to their body without the hub 30 and hollow needle 20 attached, to determine the proper amount of force required. Later, the user may add the hollow needle 20 onto the elongated handle 50 by connecting the hub 30 to the second end 54 of the elongated handle 50 and proceed to simulate an injection with the device 10. It is noted that the elongated handle 50 may be provided to a user separately from the hollow needle 20, such as, for example, if the elongated handle 50 is provided as a sample in a doctor's office and then a specific type of hollow needle 20 is determined at that time.

The device 10 may be disposable or reusable, depending on design. Commonly, the device 10 will be disposable allowing for a used injection simulation device 10 to be thrown away or disposed of This may include disposing the hollow needle 20 still attached to the elongated handle 50 into a needle waste disposal container, such as those commonly labeled “sharps container” or “biohazard container.” The device 10 may also include any other features that are common with conventional injection pens, especially features that may help properly simulate an actual injection of medicine. For example, the device 10 may include a label 80 having any number or type of graphics or icons located on the exterior surface of the elongated handle 50. This may include labels with instructions for how to use the device 10, as well as branding labels, or other identifying information. The device 10 may be designed to match a company's branding colors or design, thereby promoting the company.

FIG. 3 is a cross-sectional illustration of the injection simulation device 10, in accordance with the first exemplary embodiment of the present disclosure. FIG. 3 best illustrates the interior space 58 formed by the sidewalls 56 of the elongated handle 50. As can be seen, the interior space 58 may be enclosed by the sidewalls 56 and the end portion 70 at the first end 52. When the hub 30 is affixed to the elongated handle 50 at the second end 54, via the first and second attachment structures 40, 60, the interior space 58 may be substantially enclosed, such that the only access to the interior space 58 is through the pathway within the hollow needle 20. As can be seen in FIG. 3, the interior space 58 is empty, as it is free from structures located therein. Accordingly, it can be seen that the elongated handle 50, is a completely static structure, since there are no moving parts within the elongated handle 50. In fact, the device 10 as a whole has no moving structures once the hub 30 is properly attached to the elongated handle 50.

FIG. 3 also illustrates the positioning of the hollow needle 20 through the hub 30. As can be seen, the hollow needle 30 traverses from one side of the hub 30 the other side, which is common in conventional injection needle configurations. As is known in the art, conventional needle and hub configurations must be designed such that when the hub is attached to a conventional injection pen, the portion of the needle that is facing the injection pen can puncture a seal to release medicine. Commonly, this seal is a rubberized seal that is disposed near the opening of the injection pen. As discussed previously, the hollow needle 20 and hub 30 of the present disclosure may include the conventional configuration of the needle and hub, and therefore the hollow needle 20 may include a needle portion that is positioned to puncture a seal. However, as is shown in FIG. 3, the elongated handle 50 does not have a seal positioned within the interior space 58 that the hollow needle 20 can puncture. Therefore, when a hollow needle 20 and hub 30 with this configuration are used with the device 10, the portion of the hollow needle 20 that is facing the elongated handle 50 may simply be positioned within the interior space 58 without touching or contacting any other structures or surfaces when the hub 30 is engaged with the elongated handle 50.

Based on this understanding of the hollow needle 20, hub 30, and elongated handle 50, it can be understood that the interior space 58 of the elongated handle 50 may, in one example, be a space that is only slightly larger than the portion of the hollow needle 20 that faces the elongated handle 50. Similarly, the interior space 58 may include any dimension that is larger than the portion of the hollow needle 20 that faces the elongated handle 50. For manufacturing purposes, to save costs, a elongated handle 50 that is substantially hollow may be desired, since it will likely cost less to manufacture than an elongated handle 50 with a partially hollow interior space 58. As can be seen, the empty or hollow interior space 58 may be defined in terms of the absence of structures that can contact the portion of the hollow needle 20 that is located within the interior space 58 when the hub 30 is engaged with the elongated handle 50

FIG. 4 is a plan view illustration of the injection simulation device 110, in accordance with a second exemplary embodiment of the present disclosure. The injection simulation device 110 of the second exemplary embodiment, which may be referred herein as ‘device 110,’ may be substantially similar to the device 10 of the first exemplarily embodiment. As such, the device 110 may include any of the features, structures, or configurations discussed with respect to the first exemplary embodiment.

As is shown in FIG. 4, the device 110 includes an elongated handle 150 having a first end 152 and a second end 154. The elongated handle 150 has a sidewall 156 with an interior surface defining an interior space 158, wherein the interior space 158 is empty. An end portion 170 is integral with the sidewall 156 and may be positioned at the first end 152 of the elongated handle 150, wherein the end portion 170 encloses the first end 152 of the elongated handle 150. A first attachment structure 160 is integral with the second end 154 of the elongated handle 150. A hollow needle 120 is connected to a hub 130 having an end point 132. The end point 132 has a second attachment structure 140 engagable with the first attachment structure 160 to connect the hub 130 to the second end 154 of the elongated handle 150.

FIG. 4 illustrates an end portion 170 that is tapered. The end portion 170 is integrally positioned with the sidewall 156 of the elongated handle 150, such that the end portion 170 and the sidewall 156 may be one unitary structure. The tapered design of the end portion 170 may provide a more ergonomic or aesthetically pleasing look to the device 110. Additionally, a label 80 may be included to provide an identification of the device 110, or provide additional information about the device 110. Other designs for the end portion 170 may also be included with the device 110, as well as other designs for other components of the device 110, all of which are considered within the scope of the present disclosure.

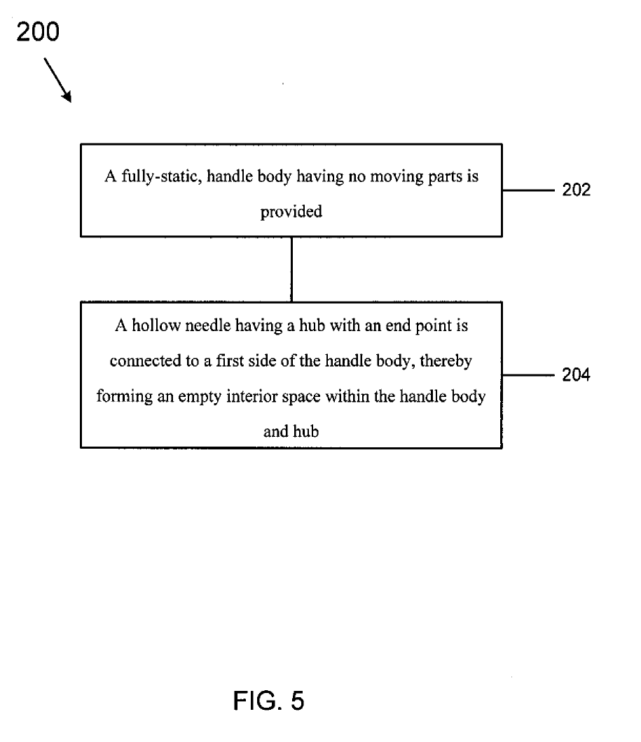

FIG. 5 is a flowchart 200 illustrating a method of constructing an injection simulation device, in accordance with a third exemplary embodiment of the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 202, a fully-static, handle body having no moving parts is provided. A hollow needle having a hub with an end point is connected to a first side of the handle body, thereby forming an empty interior space within the handle body and hub (Block 204). The method may also include any of the processes, steps, or functions described with respect to FIGS. 1-4. For example, the step of connecting the hollow needle having the hub with the end point to the first side of the handle body may include threading the end point on a threaded structure integral with the first side of the handle body. Other steps included may be directed to the construction of the device, as is described with respect to FIGS. 1-4.

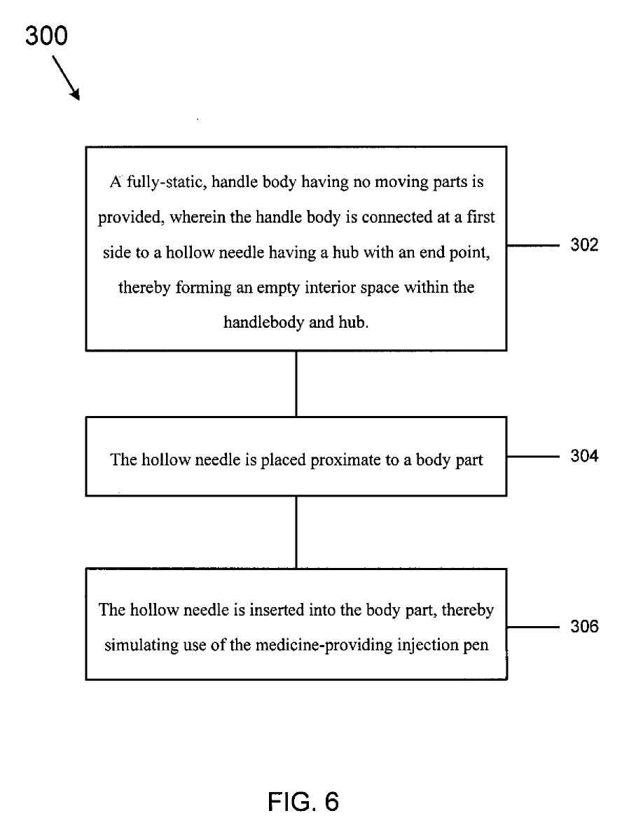

FIG. 6 is a flowchart 300 illustrating a method of using an injection simulation device, in accordance with a fourth exemplary embodiment of the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown at block 302, a fully-static, handle body having no moving parts is provided, wherein the handle body is connected at a first side to a hollow needle having a hub with an end point, thereby forming an empty interior space within the handle body and hub. The hollow needle is placed proximate to a body part (Block 304). The hollow needle is inserted into the body part, thereby simulating use of a medicine-providing injection pen (Block 306). The method may also include any of the processes, steps, or functions described with respect to FIGS. 1-5. For example, the step of providing handle body may further comprise removing the hollow needle having the hub with the end point from a sterilized packaging. Additionally, the inserted hollow needle in a medical disposal container may be disposed after the step of inserting the hollow needle into the body part.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

What is claimed is:

1. An injection simulation device comprising:
an elongated handle having a first end and a second end, wherein the elongated handle has a sidewall with an interior surface defining an interior space, wherein the interior space is empty;
an end portion integral with the sidewall and positioned at the first end of the elongated handle, the end portion enclosing the first end of the elongated handle;
a first attachment structure integral with the second end of the elongated handle; and
a hollow needle connected to a hub having an end point, wherein the end point has a second attachment structure engagable with the first attachment structure to connect the hub to the second end of the elongated handle.

2. The injection simulation device of claim 1, wherein the interior space is free from any moving structures.

3. The injection simulation device of claim 1, wherein the first attachment structure and the second attachment structure each further comprise a threaded fastener.

4. The injection simulation device of claim 1, wherein the first attachment structure and the second attachment structure each further comprise a biased fastener.

5. The injection simulation device of claim 1, further comprising an icon positioned on an exterior surface of the sidewall.

6. The injection simulation device of claim 1, wherein the hollow needle is sterile.

7. The injection simulation device of claim 1, wherein the hub with the end point engaged with the first attachment structure of the elongated handle is fully-static and has no moving parts.

8. An injection simulation device comprising:
a hollow needle connected to a hub having an end point; and
a handle body, wherein the end point of the hub is removably connected to an end of the handle body, wherein when the end point of the hub is connected the end of the handle body, the injection simulation device has no moving parts.

9. The injection simulation device of claim 8, further comprising a fastening structure positioned between the hub and the handle body, wherein the end point of the hub is removably connected to the end of the handle body with the fastening structure.

10. The injection simulation device of claim 9, wherein the fastening structure further comprises engagable threaded fasteners.

11. The injection simulation device of claim 9, wherein the fastening structure further comprises engagable biased fasteners.

12. The injection simulation device of claim 8, further comprising a substantially enclosed interior formed when the end point of the hub is connected the end of the handle body, wherein the substantially enclosed interior is connected to an external atmosphere through a fluid-transporting capable pathway within the hollow needle.

13. The injection simulation device of claim 8, further comprising a substantially enclosed interior formed when the end point of the hub is connected to the end of the handle body, wherein the enclosed interior is empty.

14. The injection simulation device of claim 8, further comprising at least one icon positioned on an exterior surface of the handle body.

15. A method of constructing an injection simulation device, the method comprising the steps of:
providing a fully-static, handle body having no moving parts; and
connecting a hollow needle having a hub with an end point to a first side of the handle body, thereby forming a empty interior space within the handle body and hub.

16. The method of constructing an injection simulation device of claim 15, wherein the step of connecting the hollow needle having the hub with the end point to the first side of the handle body further comprises threading the end point on a threaded structure integral with the first side of the handle body.

17. The method of constructing an injection simulation device of claim 15, further comprising the step of positioning an icon on an exterior surface of the handle body.

18. A method of using an injection simulation device, the method comprising the steps of:
providing a fully-static, handle body having no moving parts connected at a first side to a hollow needle having a hub with an end point, thereby forming a empty interior space within the handle body and hub;
placing the hollow needle proximate to a body part; and
inserting the hollow needle into the body part, thereby simulating use of a medicine-providing injection pen.

19. The method of using an injection simulation device of claim 18, wherein the step of providing the fully-static, handle body having no moving parts connected at the first side to the hollow needle having the hub with the end point further comprises removing the hollow needle having the hub with the end point from a sterilized packaging.

20. The method of using an injection simulation device of claim 18, further comprising the step of disposing the inserted hollow needle in a medical disposal container after the step of inserting the hollow needle into the body part.
